(19) United States
(12) Patent Application Publication
(10) Pub. No.: US 2010/0040343 A1
(43) Pub. Date: Feb. 18, 2010

(54) Method for Enhanced Seek Functionality

(75) Inventors: Bryan Mihalov, San Diego, CA (US); Edgar Tu, Poway, CA (US)

Correspondence Address: CROWELL & MORING LLP;INTELLECTUAL PROPERTY GROUP, P.O. BOX 14300, WASHINGTON, DC, 20044-4300, US

(73) Assignees: SONY CORPORATION, Tokyo (JP); SONY ELECTRONICS INC., Park Ridge, NJ (US)

(21) Appl. No.: 12/190,457

(22) Filed: Aug. 12, 2008

(51) Int. Cl. H04N 5/91

(52) U.S. Cl. 386/68

(57) ABSTRACT

Enhanced seek functionality is provided during media content playback when a user desires to move forward or backward to a different playback position within a digital media presentation. In response to a user seek command, the current seek position may be moved forward or backward at a seek speed that is a predefined multiple of the standard playback speed. After a predetermined number of subsequent seek commands has been provided, any seek command provided thereafter may cause the current seek position to move by a predetermined percentage of the total duration of the digital media presentation. In one embodiment, additional seek commands thereafter may similarly result in the current seek position again being moved forward or backward by the predetermined percentage of the total duration of the digital media presentation.

### FIELD OF THE INVENTION

The present invention relates in general to digital content navigation, and in particular to providing enhanced functionality for seeking through digital video and/or audio content.

### BACKGROUND

Modern media players (e.g., personal video recorders (PVRs), digital video disc (DVD) player, set-top boxes (STBs), etc.) allow users to advance or reverse through digital video and/or audio content at a number of preset speeds. When a user wants to move forward or backward to view or listen to a different part of the digital content currently being played, a user will typically press a seek button on a remote control or other user input device. For example, this seek button may be in the form of left/right buttons or advance/reverse buttons on a remote control. Each successive press of a seek button will cause the seek cursor (which defines the current seek position) to move forward or backward at successively increasing or decreasing speeds. These preset speeds are defined as a multiple of the standard playback speed (e.g., −3×, −2×, −1×, 0, 1×, 2×, 3×, etc.).

Unfortunately, for lengthy presentations it may still take an inconvenient amount of time to reach the part of the digital content that the user desires to view or listen to. Adding additional faster preset seek speeds is not a viable solution since it becomes increasingly too difficult for the user to properly stop the seek operation near the desired viewing point. As such, what is needed is a method for providing enhanced seek functionality which overcomes the aforementioned drawbacks.

### BRIEF SUMMARY OF THE INVENTION

Disclosed and claimed herein are methods for enhanced seek functionality. In one embodiment, a method for providing seek functionality includes presenting a digital media presentation by a media player, entering a seek mode upon receiving a forward seek command, and advancing a current seek position for the digital media presentation at a seek speed equal to a predefined multiple of a standard playback speed. The method further includes increasing the seek speed, in response to receiving additional forward seek commands while in the seek mode, up to a predetermined number of times, and then advancing the current seek position a predetermined percentage of a total duration of the digital media presentation in response to receiving a subsequent forward seek command after the seek speed has already been increased the predetermined number of times.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is one embodiment of a system configured to implement one or more embodiments of the invention;

FIG. 2 is a process for carrying out one or more aspects of the invention; and

FIGS. 3A-3B depicts an optional aspect of enhanced seek functionality according to one embodiment of the invention.

### DETAILED DESCRIPTION OF EXEMPLARY EMBODIMENTS

### Disclosure Overview

One aspect of the disclosure relates to a process, performed by a media player, for providing enhanced seek functionality. During media content playback, a user may move forward or backward to a different playback position within the digital media presentation by providing a seek command to the media player. Receiving a seek command may then cause the media player to enter a seek mode during which the current seek position is moved, either forward or backward, at a seek speed that is a predefined multiple (e.g., 2×) of the standard playback speed. In certain embodiments, it may be desirable to show the current seek position during seek mode as a seek cursor or head in a trick play bar overlaid on the media presentation.

Should the user desire to move more quickly through the media presentation, the user may provide another seek command to the media player, which is already in seek mode by virtue of the first seek command. In one embodiment, this subsequent seek command may cause the seek speed to increase to some higher multiple (e.g., 3×) of the standard playback speed. Subsequent seek commands received while in seek mode may incrementally cause the seek speed to increase as a function of the standard playback speed, up to some predetermined number of seek commands (e.g., 3, 4, etc.). In one embodiment, the user may exit the seek mode using a predefined user input, such as pressing a play or enter button on a remote control, at which point the media presentation may resume standard playback beginning from the final seek position. Alternatively, the seek mode may be automatically exited upon reaching the end or beginning of the digital media presentation.

Another aspect of the invention is to provide the user with enhanced seek functionality, whereby the user is able to seek forward or backward to a different playback position more quickly and not simply as a multiple of the standard playback speed. To that end, in one embodiment, once the aforementioned predetermined number of seek commands is reached, any seek command provided thereafter may cause the current seek position to move by a predetermined percentage (e.g., 5%-25%) of the total duration of the digital media presentation. Additional seek commands thereafter may similarly result in the current seek position again being moved forward or backward by the predetermined percentage of the total duration of the digital media presentation. In this fashion, a user is able to traverse lengthy media presentations more quickly and precisely.

Still another aspect of the invention is to provide position-based speed adjustment for seek operations. In one embodiment, the seek speed may automatically reduce as the current seek position approaches either the beginning or the end of the digital media presentation.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium or transmitted by a computer data signal. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc.

### Exemplary Embodiments

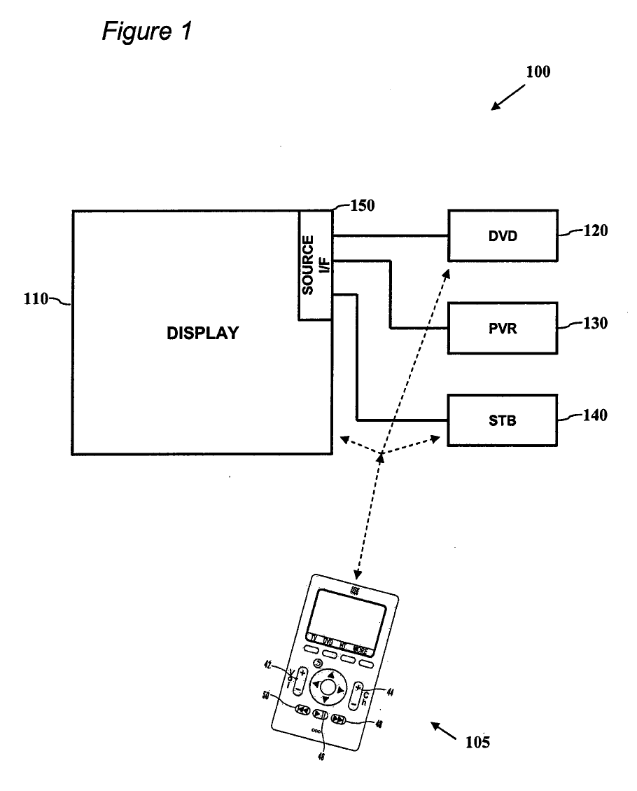

Referring now to FIG. 1, depicted is one embodiment of a system 100 configured to implement one or more embodiments of the invention. In particular, the system 100 includes a remote control 105, a display device 110 (e.g., television), and one or more content source devices (e.g., DVD 120, PVR 130 and STB 140). In one embodiment, the remote control 105 is capable of being used in combination with a digital media player to implement one or more aspects of the invention. As shown, the remote control 105 may include conventional input elements such as, but not limited to, a volume up/down rocker 42, a channel up/down rocker 44, a play/stop button 46, a fast forward button 48, and a reverse or rewind button 50. Additionally, the remote control 105 may have a navigation control element for moving a screen cursor around a display screen in accordance with principles known in the art, and a visual display such as a liquid crystal display (LCD).

In addition to the above input and output elements, the remote control 105 may further include one or more mode buttons, such as a “TV” mode button, a “DVD” mode button, a “home theater” mode button, and a “more” mode button, as shown in FIG. 1. It should of course be appreciated that the remote control 105 of FIG. 1 is but one example of a user input device usable in conjunction with the principles of the invention. Numerous other remote control embodiments may be used, as well as other forms of user input devices, including user inputs integrated into a digital media player itself.

Continuing to refer to FIG. 1, the display 110 is in communication with one or more of the DVD 120, PVR 130 and STB 140 via a source interface circuit 150, such as HDMI, DVI, digital audio, 1394, component video, S-Video, composite, etc. It should also be appreciated that other types of source devices not depicted in FIG. 1 may be used to implement the invention, including but not limited to music players (portable or otherwise). In general, any electronic device that stores and plays digital audio or video content may be used in conjunction with the invention.

In a typical embodiment, the system 100 will respond accordingly to commands or inputs from the remote control 105, such as pressing the volume up/down rocker 42 to increase or decrease the volume, changing the channel to which the display 110 is tuned using the channel up/down rocker 44, playing or stopping the presentation of media content using the play/stop button 46, advancing or rewinding the media being played back using the fast forward button 48 or reverse/rewind button 50.

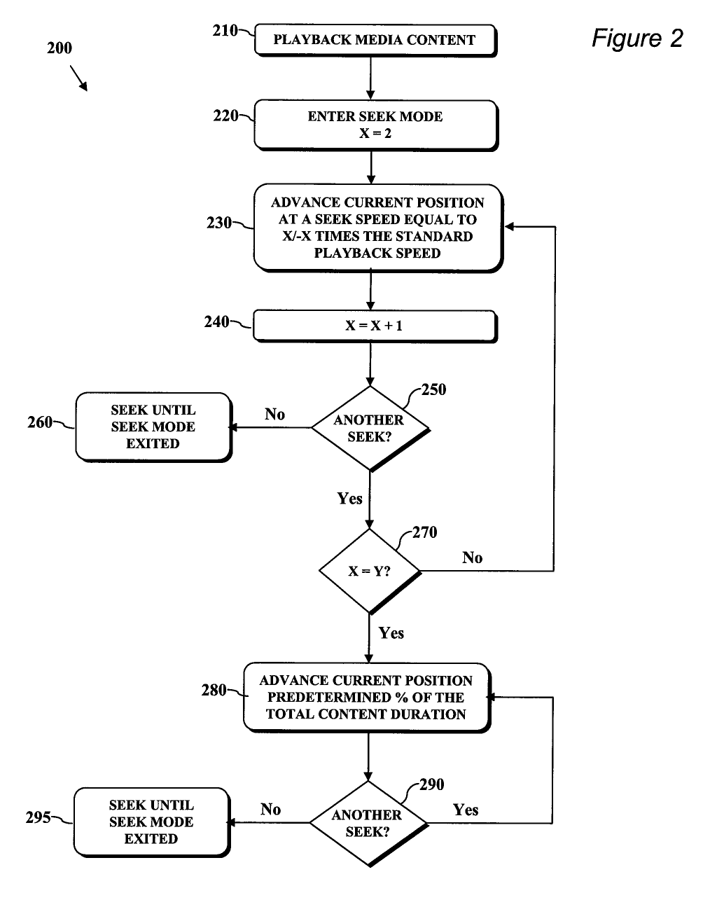

Referring now to FIG. 2, depicted is one embodiment of a process performed by a media player (e.g., DVD 120, PVR 130, STB 140, mp3 player), consistent with the principles of the invention. In particular, process 200 begins at block 210 where media content playback is initiated. During playback, a user may desire to move forward or backward to a different playback position within the digital media presentation. To do so, the user may provide a seek command using any user input means, such as remote control 105 of FIGS. 1A-1B to the media player. At block 220, the media player may respond to the seek command by entering into a seek mode. In addition, a seek counter X may be set equal to 2 at block 220, although it should of course be appreciated that in other embodiments X may be set to some other value (e.g., 1, 1.5, 2.5, 3, etc.).

While the seek command provided at block 220 may comprise either a fast forward command (e.g., using fast forward button 48 of remote control 105) or a rewind/reverse command (e.g., using reverse/rewind button 50 of remote control 105), for purposes of the exemplary embodiment of FIG. 2, it is assumed that a forward seek command was provided at block 220.

In response to the forward seek command, and while in seek mode, the media player may advance the current seek position for the digital media presentation at a seek speed equal to a predefined multiple of the standard playback speed (block 230). For example, when X=2, the forward seek command may cause the media player to seek forward through the digital media presentation at two times (2×) the standard playback speed. If X=3, then the seek speed would be three times (3×) the standard playback speed. While in one embodiment, the current seek position may be denoted as a cursor in a standard trick play bar, it should equally be appreciated that other means of identifying the current seek position would be consistent with the principles of the invention.

Although the embodiment of FIG. 2 relates to a forward seek command, in the case of a reverse seek command the media player would similarly seek backwards through the digital media presentation at some multiple of the standard playback speed (e.g., 2×, 3×, etc.).

After incrementing the seek counter X at block 240, process 200 may continue to block 250 where a determination may be made as to whether another forward seek command has been received from the user. If not, process 200 may continue to block 260 where the media player will continue to seek at the current speed until the seek mode is exited. In one embodiment, the user may exit the seek mode using a predefined user input, such as pressing a play or enter button on a remote control (e.g., remote control 105). Upon exiting the seek mode, the digital media presentation may resume standard playback beginning from the last seek position before such exiting. Similarly, seek mode may be exited automatically upon reaching the end (or beginning) of the digital media presentation.

If, on the other hand, a determination is made at block 250 that another seek command has been received from the user, process 200 may continue to block 270 where a determination may be made as to whether the seek counter X has reached a predetermined number of increments Y. In one embodiment, Y equals X+3, in which case there would be 3 seek speeds that are progressively increasing multiples of the standard playback speed. It should of course be appreciated that Y may equally be any integer that is greater than X.

If it is determined that the seek counter X has not reached the predetermined number of increments Y, process 200 may revert back to block 230 where, in response the forward seek command of block 250, the media player may advance the current seek position for the digital media presentation at the new incrementally increased seek speed. Process 200 may then repeat the operations of block 230-270 until the seek counter X reaches the predetermined number of increments Y.

Once it is determined at block 270 that the seek counter X has reached the predetermined number of increments Y, process 200 will continue to block 280 where the current seek position will be advanced by a predetermined percentage of a total duration of the digital media presentation. While in one embodiment, the predetermined percentage may be 10%, in other embodiments it may be between 5-25%.

By way of providing a non-limiting example, assume that the predetermined percentage for block 280 is 10% and that the media presentation has a playback duration of 2 hours long. In that case, the current seek position would be advanced 20 minutes at block 280. It should further be appreciated that, prior to block 280, it may be necessary to determine what the total duration of the media presentation is.

At this point, process 200 may continue to block 290 where a determination is made as to whether another forward seek command has been received from the user. If not, process 200 may continue to block 295 where the media player will continue to seek at the current speed, but from the now-advanced current seek position, until the seek mode is exited. In one embodiment, the user may exit the seek mode using a predefined user input, such as pressing a play or enter button on a remote control (e.g., remote control 105), at which point the media presentation may resume standard playback beginning from the final seek position. Alternatively, the seek mode may be automatically exited upon reaching the end or beginning of the digital media presentation.

If, on the other hand, it is determined at block 290 that another seek command has been received from the user, process 200 may repeat the operation of block 280 where the current seek position is again advanced by the predetermined percentage of the total duration of the digital media presentation. In certain embodiments, each subsequent seek command at this point will advance the current seek position by the predetermined percentage until the user manually exits seek mode, or the end of the media presentation is reached.

As mentioned above, it should equally be appreciated that the principles of the invention in general, and process 200 in particular, may equally be applied to a backward seek command where the user desires to reserve or rewind at least a portion of the digital media presentation. In addition, it should be appreciated that moving the current seek position by the predetermined percentage of the total duration of the digital media presentation may occur instantly by having the current seek position jump the predetermined percentage of time. Alternatively, the current seek position may move rapidly through the predetermined percentage of time, but not instantly.

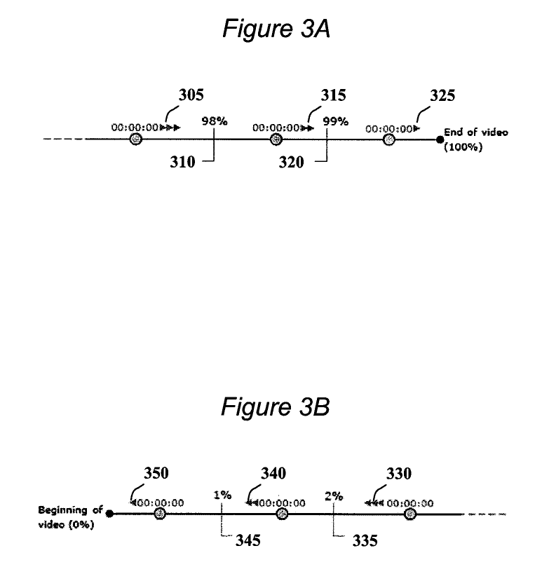

Referring now to FIGS. 3A-3B, depicted are two embodiments how position-based speed adjustment for seek operations may be provided. With reference first to FIG. 3A, depicted is a graphical representation of a current seek position (denoted by the round cursor or seek head) having a seek speed that is automatically reduced as the current seek position approaches the end of the digital media presentation. In particular, indicator 305 indicates that the seek speed is at the third level, which may correspond to having received a forward seek command 3 successive times. Once the current seek position reaches position 310, however, the seek speed may be automatically reduced to the next slower level or multiple of the standard playback speed (e.g., corresponding to two seek commands), as shown by indicator 315. While in the embodiment of FIG. 3A, position 310 corresponds to the point where the current seek position is within 2% of the end of the digital media presentation, it should equally be appreciated that position 310 may occur either closer or further from the end of the presentation.

Continuing to refer to FIG. 3A, unless stopped by the user, the seek speed will remain constant until the current seek position reaches position 320, at which point the seek speed may again be automatically reduced to the next slower level or multiple of the standard playback speed (e.g., corresponding to one seek command), as shown by indicator 325. While position 320 corresponds to the point where the seek position is within 1% of the end of the digital media presentation, position 320 may similarly occur either closer or further from the end of the presentation. In this fashion, the user may be alerted to the fact that the end of the media presentation is approaching and be given ample opportunity to respond accordingly.

Referring now to FIG. 3B, depicted is a graphical representation of a current seek position (denoted by the round cursor or seek head) having a seek speed that is automatically reduced as the current seek position approaches the beginning of the digital media presentation. While the embodiment of FIG. 3A corresponds to a forward seek operation, the embodiment of FIG. 3B corresponds to a reverse seek operation. In particular, indicator 330 indicates that the reverse seek command has been received 3 times and that the current seek position is moving backwards at the corresponding multiple of the standard playback speed. Once the current seek position reaches position 335, however, the seek speed may be automatically reduced to the next slower level or multiple of the standard playback speed (e.g., corresponding to two seek commands), as shown by indicator 340. While in the embodiment of FIG. 3B, position 335 corresponds to the point where the seek position is within 2% of the beginning of the digital media presentation, it should equally be appreciated that position 335 may occur either closer or further from the beginning of the presentation.

Continuing to refer to FIG. 3B, unless the seek mode is exited by the user, the seek speed will remain constant until the current seek position reaches position 345, at which point the seek speed may again be automatically reduced to the next slower level or multiple of the standard playback speed (e.g., corresponding to one seek command), as shown by indicator 350. While position 345 corresponds to the point where the seek position is within 1% of the beginning of the digital media presentation, this position may similarly occur either closer or further from the beginning of the presentation. In this fashion, the user may be alerted to the fact that the beginning of the media presentation is approaching and be given ample opportunity to respond accordingly.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. A method for providing seek functionality comprising the acts of:
presenting a digital media presentation by a media player;
entering a seek mode upon receiving a forward seek command;
advancing a current seek position for the digital media presentation at a seek speed equal to a predefined multiple of a standard playback speed;
increasing the seek speed, in response to receiving additional forward seek commands while in the seek mode, up to a predetermined number of times;
advancing the current seek position a predetermined percentage of a total duration of the digital media presentation in response to receiving a subsequent forward seek command after the seek speed has already been increased the predetermined number of times.

2. The method of claim 1, further comprising determining when the seek speed has been increased the predetermined number of times.

3. The method of claim 1, further comprising determining the total duration of the media presentation.

4. The method of claim 1, further comprising exiting the seek mode in response to one of a user input or reaching the end of the media presentation.

5. The method of claim 1, further comprising incrementing a seek counter from an initial value in response to the forward seek command.

6. The method of claim 5, further comprising incrementing the seek counter in response to receiving each of the additional forward seek commands, up to the predetermined number of times.

7. The method of claim 1, wherein in the predetermined percentage is between 5% and 25% of the total duration of the digital media presentation.

8. The method of claim 1, wherein further comprising decreasing the seek speed in response to the current seek position reaching a predetermined percentage from an end of the digital media presentation.

9. A method for providing seek functionality comprising the acts of:
presenting a digital media presentation by a media player;
entering a seek mode upon receiving a backward seek command;
rewinding a current seek position for the digital media presentation at a seek speed equal to a predefined multiple of a standard playback speed;
increasing the seek speed, in response to receiving additional backward seek commands while in the seek mode, up to a predetermined number of times;
rewinding the current seek position a predetermined percentage of a total duration of the digital media presentation in response to receiving a subsequent backward seek command after the seek speed has already been increased the predetermined number of times.

10. The method of claim 9, further comprising determining when the seek speed has been increased the predetermined number of times.

11. The method of claim 9, further comprising determining the total duration of the media presentation.

12. The method of claim 9, further comprising exiting the seek mode in response to one of a user input or reaching the beginning of the media presentation.

13. The method of claim 9, further comprising incrementing a seek counter from an initial value in response to the backward seek command.

14. The method of claim 13, further comprising incrementing the seek counter in response to receiving each of the additional backward seek commands, up to the predetermined number of times.

15. The method of claim 9, wherein in the predetermined percentage is between 5% and 25% of the total duration of the digital media presentation.

16. The method of claim 9, wherein further comprising decreasing the seek speed in response to the current seek position reaching a predetermined percentage from a beginning of the digital media presentation.

17. A media player comprising:
a memory containing instruction sequences; and
a processor coupled to the memory, the processor configured to execute the instruction sequences to,
provide a digital media presentation to a display,
enter a seek mode upon receiving a seek command,
move a current seek position for the digital media presentation at a seek speed equal to a predefined multiple of a standard playback speed;
increase the seek speed, in response to receiving additional seek commands while in the seek mode, up to a predetermined number of times;
move the current seek position a predetermined percentage of a total duration of the digital media presentation in response to receiving a subsequent seek command after the seek speed has already been increased the predetermined number of times.

18. The media player of claim 17, wherein the processor is further configured to execute the instruction sequences to determine when the seek speed has been increased the predetermined number of times.

19. The media player of claim 17, wherein the processor is further configured to determine the total duration of the media presentation.

20. The media player of claim 17, wherein the processor is further configured to exit the seek mode in response to one of a user input or reaching the end of the media presentation.

21. The media player of claim 17, wherein the processor is further configured to increment a seek counter from an initial value in response to the forward seek command.

22. The media player of claim 21, wherein the processor is further configured to increment the seek counter in response to receiving each of the additional forward seek commands, up to the predetermined number of times.

23. The media player of claim 17, wherein in the predetermined percentage is between 5% and 25% of the total duration of the digital media presentation.

24. The media player of claim 17, wherein the processor is further configured to decrease the seek speed in response to the current seek position reaching a predetermined percentage from an end or beginning of the digital media presentation.
